(19) United States
(12) Patent Application Publication
(10) Pub. No.: US 2019/0012642 A1
(43) Pub. Date: Jan. 10, 2019

(54) METHOD AND SYSTEM FOR MOBILE VISITOR IDENTIFICATION AND SELECTIVELY ALLOWING AUTOMATED ELEVATOR USAGE TO THE DESTINATIONS SELECTED BY THE TENANT

(71) Applicant: INDOOR.NINJA OÜ, Harjumaa (EE)

(72) Inventors: Madis LAAS, Harjumaa (EE); Peep PAUM, Harjumaa (EE); Henrik EELTEE, Harjumaa (EE)

(73) Assignee: INDOOR.NINJA OÜ, Harjumaa (EE)

(21) Appl. No.: 15/752,461

(22) PCT Filed: Aug. 13, 2015
(86) PCT No.: PCT/EE2015/000006

§ 371 Date: Feb. 13, 2018

Related U.S. Application Data
(63) Continuation-in-part of application No. PCT/EE2015/000006, filed on Aug. 13, 2015.

(51) Int. Cl. G06Q 10/10; G06Q 10/06; B66B 1/46; B66B 1/28

(52) U.S. Cl. CPC G06Q 10/10; G06Q 10/06; B66B 2201/4623; B66B 1/28; B66B 1/468

(57) ABSTRACT

An online communication device mobile application and tablet computer mobile application based system to directly connect visitors with the tenants in commercial and residential buildings. The application helps to efficiently transport visitors from the public access areas to secure destination floors via the elevator, after the tenant has given the necessary command to the system which will grant the visitor access. The invention also eliminates the need for a receptionist to identify visitors and manage elevator access.

This nonprovisional application is a National Stage of International Application No. PCT/EE2015/000006, which was filed on Aug. 13, 2015, is herein incorporated by reference.

### BACKGROUND OF THE INVENTION

### Field of Invention

The invention relates to the accessibility and elevator control systems of residential and commercial buildings.

### Description of the Background Art

In many conventional small and medium sized office buildings, there is a receptionist that acts as a basic security measure against unwanted visitors. Buildings are now moving towards automated systems and the need for a conventional receptionist is rapidly decreasing. At the moment many receptionist are left only to solve unexpected situations and provide basic security.

Most conventional methods for visitor identification require either a form of preparation prior to the visit; physical interaction with the receptionist or presume the visitor to carry an identification card.

Most conventional systems that are used for contacting tenants from the public areas of a building involve a component that is fixed onto the premises. This creates a situation where tenants need to constantly move to answer the visitor which can become tiresome and limits the mobility of the tenant.

Most small and medium sized office buildings have a conventional elevator calling system, where the destination floor can only be selected once one enters the elevator, thus providing less efficient use of the elevator.

With the current invention, the visitor does not require any form of preparation prior to the visit. It creates a direct contact between the visitor and the host even if the host is moving around in the building. The host can grant the visitor access to a secure area of the building, where the host is currently located. The elevator is called for the visitor as a destination call, thus ensuring the most efficient elevator usage and minimizing the risk of the visitor exiting on the wrong floor.

Patent publication US2013031611 describes a web-enabled entry system for controlling the access of visitors to a residential, commercial or institutional facility having or not receptionist at the entry point, where the visitors to such a facility should be authorized and/or the visit event should be recorded in a database.

The described publication is a system for personal identification and sending a one-way signal as permission for operation of the access control system in case of the positive identification by the tenant user. The mentioned operation is commonly unlocking or opening an entrance point. There are limited activities that can be made and limited amount of information that can be collected and stored with a one-way communication system. The system in its simple form and without a physical human presence monitors only the given access.

The current invention is a two-way interaction with the elevator, where the visitor can be automatically sent to the floor where the tenant user is currently located.

The invention also creates a log of processes that also includes the possible stops of the visitor's journey.

### SUMMARY OF THE INVENTION

It is therefore an object of the present invention to provide a system for mobile visitor identification and selectively allowing automated elevator usage to the destination selected by the tenant.

The system is comprised of:
a system web server for storing the website, user databases and for facilitating the process of connecting the tablet computer, the tenant communication device and the elevator provider's web server;
the elevator provider's web server, that is communicated via the application programming interface. It is given by the elevator provider for sending the elevator operational requests, requests for information and for receiving information about the building and elevator.
a building manager computer interface which is used to access the website in the system web server to insert and to administrate data in the building databases;
a tenant manager computer interface is used to access the website in the system web server, to insert and administrate the tenant mobile application access, access floors and access elevator groups;
a tablet computer that is used as a hardware platform to interact with the mobile tablet application. The tablet allows to:
   request contact with the tenant by first selecting the destination tenant company and then the specific tenant person from the tablet computer user interface;
   display messages that help guide the visitor through the process of requesting access;
   communicate with the visitor through an integrated tablet loudspeaker;
an integrated camera of the tablet computer that is used to capture a live footage of the visitor, who is requesting access to the secured area of the building
a tenant communication device that is used as a hardware platform to interact with the mobile application. The tenant communication device allows to:
   receive the live stream sent from the tablet computer through the system web server
   send elevator action requests to the system web server which will communicate with the elevator provider's web server receive and display data about the elevator status.

The method comprising the steps of:
a visitor selects the tenant group and the tenant name which causes the system to send a request to the system web server;
the system web server sends a notification to the mobile application in the tenant communication device
the tenant opens the mobile application, identifies the visitor using an opened video stream with an audio channel and then gives access
the tenant mobile application sends the access confirmation to the system web server
the system web server sends a request for a destination call to the elevator server
the elevator server orders an elevator for the visitor
the visitor enters the elevator and the elevator moves to the current tenant location floor.

The objective of the invention is to create a direct audio visual connection between the tenant and the visitor for the purpose of obtaining access to secured areas of the building. The access point for the secured area in the current invention is the elevator and secured areas are separated from the public areas by locating on different floors.

An objective is to identify the visitor without the need of third party assistance nor any physical device or document. The invention incorporates a touch capable tablet computer for the visitor and a communication device used by the tenant user to run the mobile applications. A web server is used to store the data and facilitate the process. This allows the visitor to reach the host directly.

Another objective is to provide convenience by allowing the visitor to request access with a minimum of two taps on the touch capable screen of the tablet computer.

Another objective is to monitor the process of visitor navigating through the building and minimize the possibility for errors by automatically delivering the visitor to the tenant location floor. The tenant will be able to monitor the process of the visitor moving through the building.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1.1 is a schematic block diagram illustrating the components of the system and showing the communication aspect and elevator control system within the building.

FIG. 1.2 is a schematic flow diagram illustrating a method for granting the visitor access to the secured areas of the building through the elevator.

FIG. 2.1 is a schematic view of the screen layout of the tablet computer mobile application during the building manager identification and activation process of the tablet mobile application.

FIG. 2.2 is a schematic view of the screen layout of the tablet computer mobile application during its standby mode.

FIG. 2.3 is a schematic view of the screen layout of a tablet computer mobile application when the user makes the selection to find the tenant by its name from the list of all tenant names.

FIG. 2.4 is a schematic view of the screen layout of a tablet computer mobile application after the user has selected the tenant group.

FIG. 2.5 is a schematic view of the screen layout of a tablet computer mobile application after the user has selected the tenant name and during the process of reaching the tenant.

FIG. 2.6 is a schematic view of the screen layout of a tablet computer mobile application that shows the destination floor and the elevator that has to be used after the tenant has granted access.

FIG. 2.7 is a schematic view of the screen layout of a tablet computer mobile application that shows the message from the tenant or system after the request has not been answered or access has been denied.

FIG. 3.1 is a schematic view of the screen layout of a tenant communication device during the tenant log in and identification process.

FIG. 3.2 is a schematic view of the screen layout of a tenant communication device when the mobile application is not processing any requests.

FIG. 3.3 is a schematic view of the screen layout of the tenant communication device mobile application settings panel.

FIG. 3.4 is a schematic view of the screen layout of a tenant communication device when there is an identification request in process.

FIG. 3.5 is a schematic view of the screen layout of a tenant communication device when the audio channel is active.

FIG. 3.6 is a schematic view of the screen layout of a tenant communication device, when the visitor is being transported.

FIG. 3.7 is a schematic view of the screen layout of a tenant communication device, when the tenant is requesting an elevator call.

### DETAILED DESCRIPTION

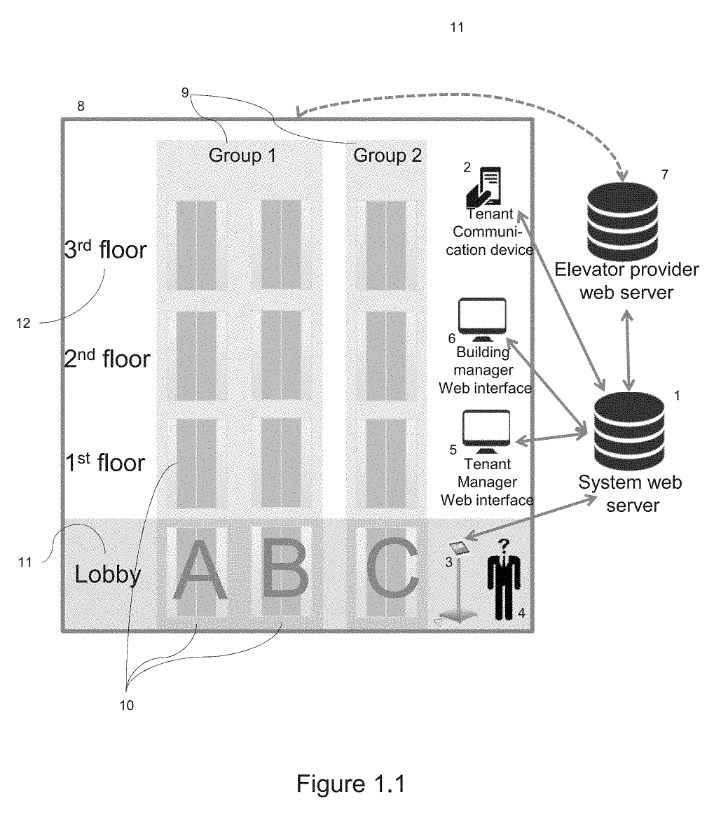

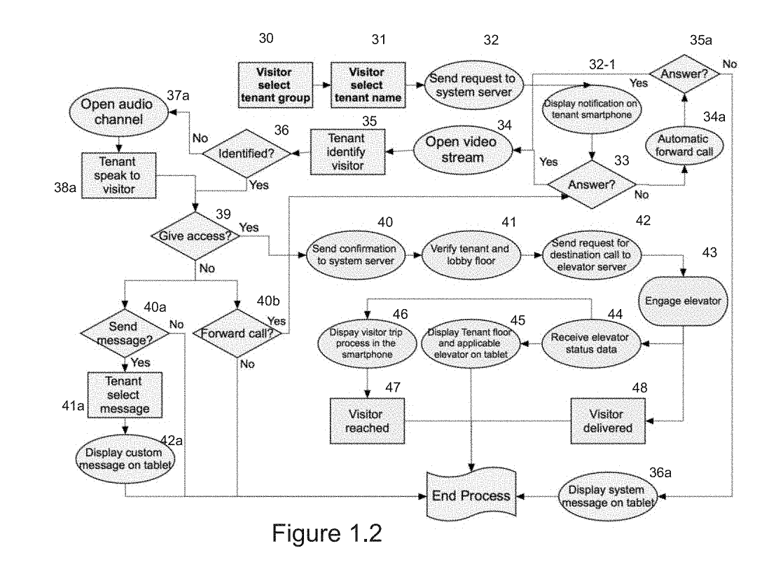

As described in FIG. 1.1, the system consists of a tablet computer 3 and tenant communication device 2 each equipped with an integrated touch sensitive screen, an integrated front camera, an integrated microphone and an integrated loudspeaker. The tablet computer and tenant communication device are both directly communicating with the system web server 1 via a WiFi connection or via any available mobile telecommunication technology (such as 3G or 4G) to provide Internet connectivity. As described in FIG. 1.1 the tablet is located in the public area 11 of the building (for example the lobby) and the tenant communication device 2 is most commonly located with the tenant in the secure area of the building 12, but has no restrictions in location regarding to the functionality of the system. Tablet computer 3 is used as a hardware platform to interact with the mobile application, which is used to request contact with the tenant by selecting the tenant company and the tenant from the tablet computer 3 user interface. Display messages help guide through the process of requesting access and communicating with the visitor 4 through an integrated tablet loudspeaker. The integrated camera of the tablet computer will be used to capture a live footage of the visitor 3, who is requesting to get access to the secured area of the building. The live stream and information of the requested tenant will be sent to the system web server 1 from the tablet computer mobile application 3. The tenant communication device 2 is used as a hardware platform to interact with the mobile application, which is used to receive the live stream sent from the tablet computer 3 to the system web server 1, send elevator action requests 11 to the system web server which will communicate the elevator provider's web server 7 and receive and display data about the elevator 12 status

The system web server 1 processes all user requests from the tenant communication device's mobile application 3 and tablet computer mobile application 3 It facilitates the process of all communication between the tablet computer 3, tenant communication device 2, building manager web interface 6, tenant manager web interface 5 and the elevator provider's web server 7. The building manager computer interface 6 is used to access the web based database management system. The list of all the managed buildings; information about the buildings; building manager contact information; billing information and subscription details; the list, location and interface language data of tablet computer mobile applications and the list of tenants, their contact details, accessed floors 12 and elevator groups 9 can be obtained and/or modified through the building manager computer interface 6. The tenant manager computer interface 5 is used to access the web based database management system. Tenant company information; manager contact information; billing information and subscription details; the list of tenant users, their contact information and accessed floors 12 and elevator groups 9 can be obtained and/or modified through the tenant manager computer interface 5. The system web server 1 communicates directly to the elevator provider's web server 7 via the application programming interface. The system web server 1 sends requests to the elevator provider's web server 7 for information, such as building administrator identification code, building information (building location, size, amount of elevators etc.), current status of the elevators and requests for elevator actions.

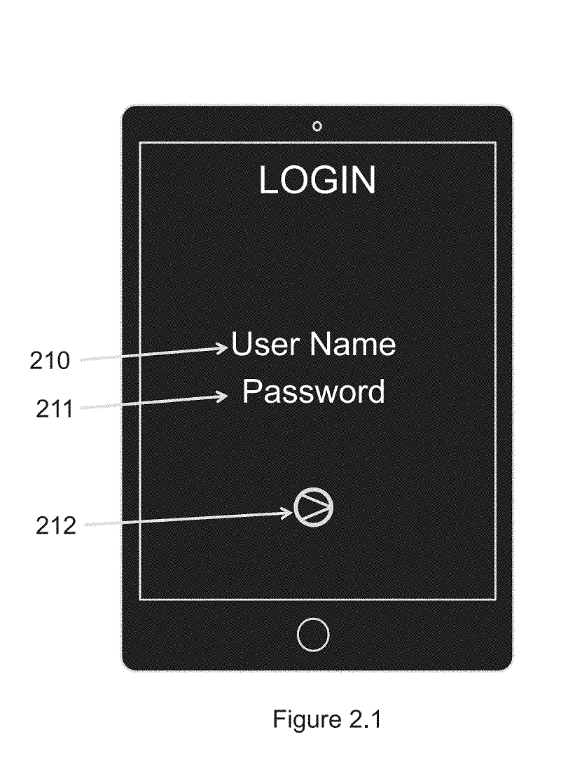

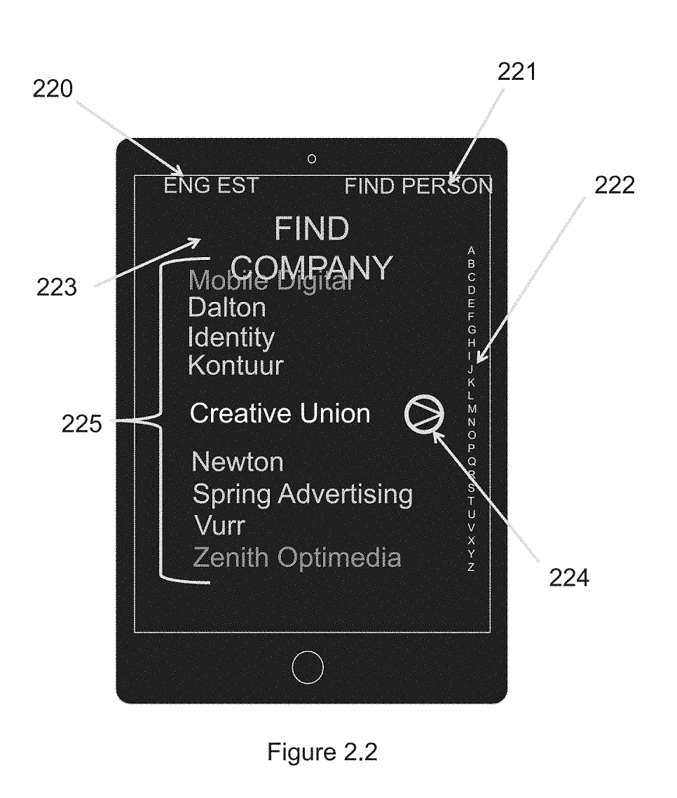

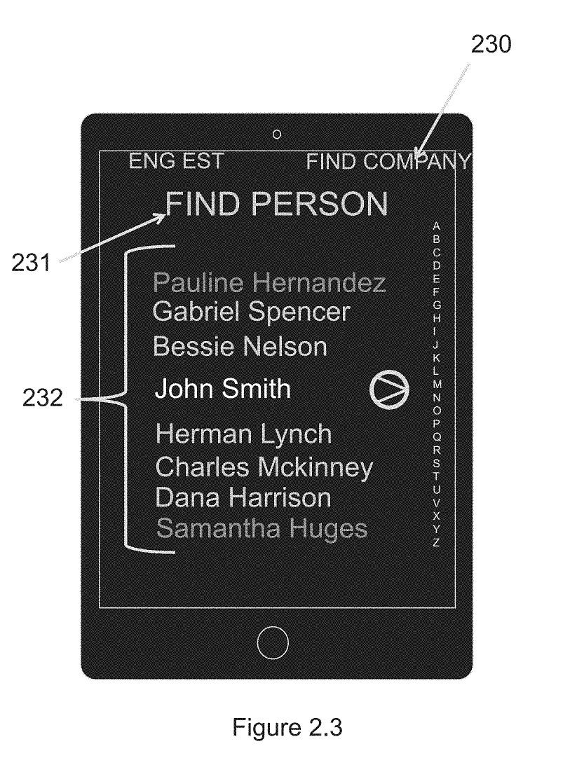

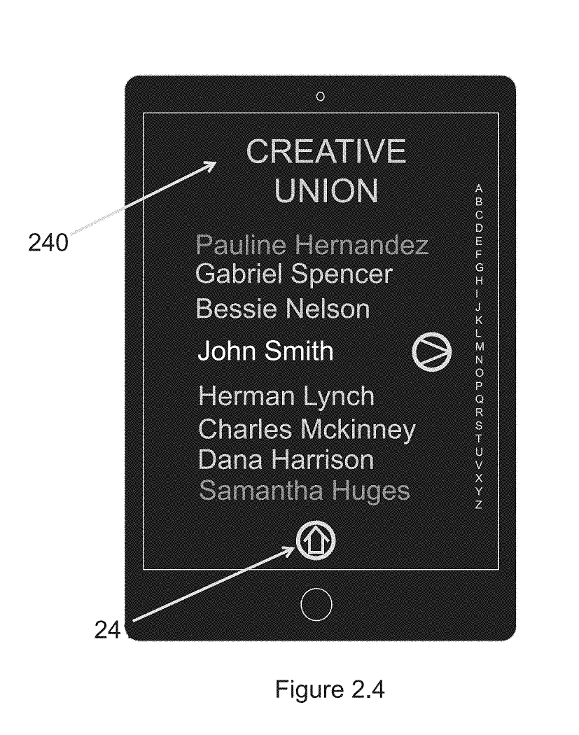

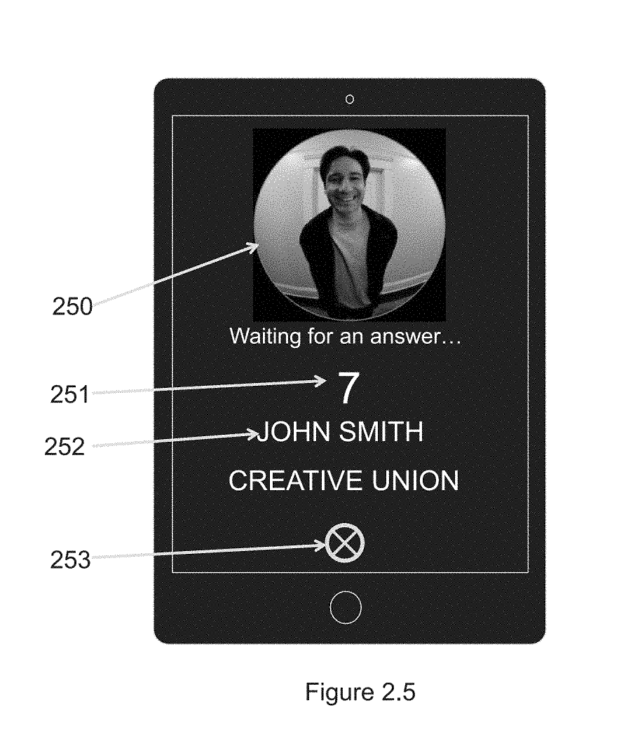

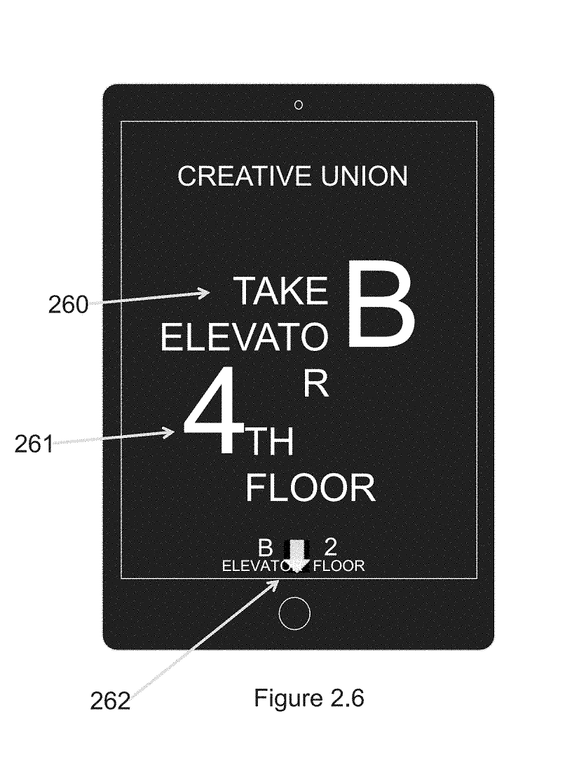

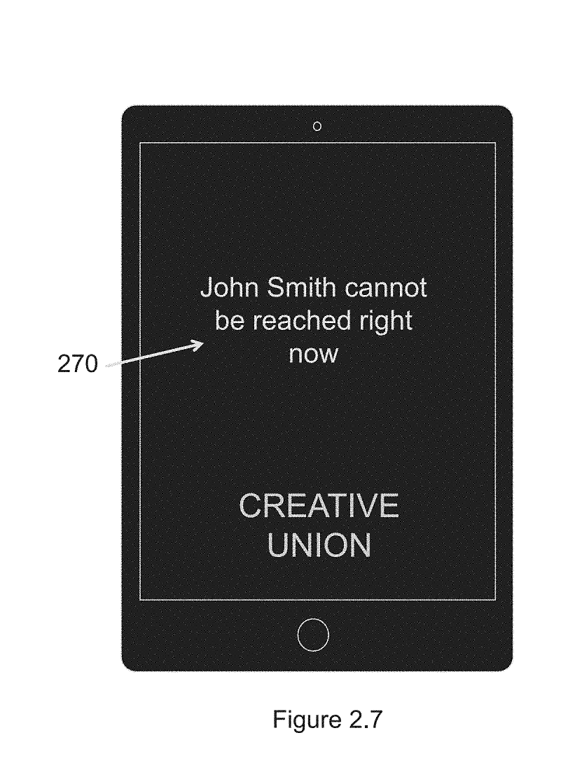

As described in the activity process flowchart in FIG. 1.2, the visitor selects a tenant group 30, that will take him to the next screen where a list of the corresponding tenants 232 (FIG. 2.3) will displayed. Alternatively the user can skip the tenant group selection, by pressing the users list button 221 where the list of tenant names will be displayed in full as in FIG. 2.3. The request is sent 32 to the system web server 1. The visitor then selects the desired tenant name 31. The request is then processed and a notification will be opened 32-1 in the tenant communication device 2. The tenant is then requested to open the mobile application.

When the mobile application in the tenant communication device 2 is not opened in a predetermined period of time, the call will automatically be forwarded 34a to the predefined secretary user. If the secretary user notification is not answered 35a in predetermined period of time, a predefined message 36a is displayed in the tablet computer mobile application 3.

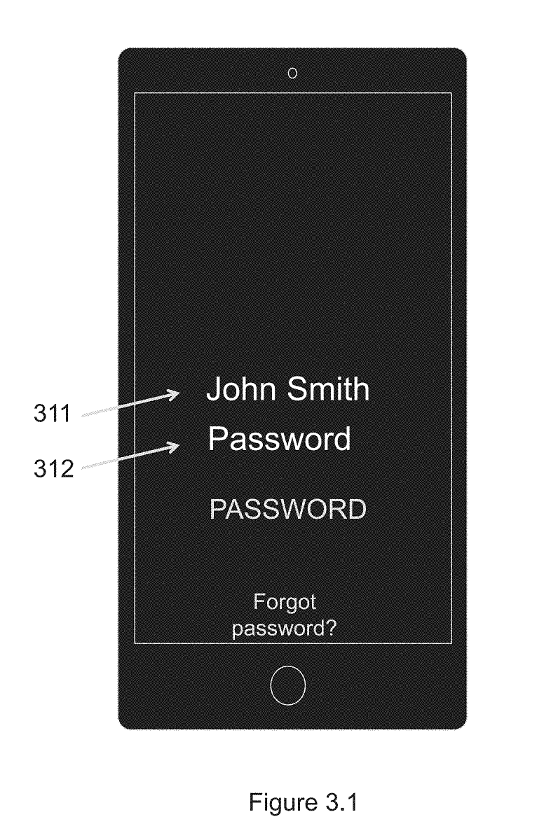

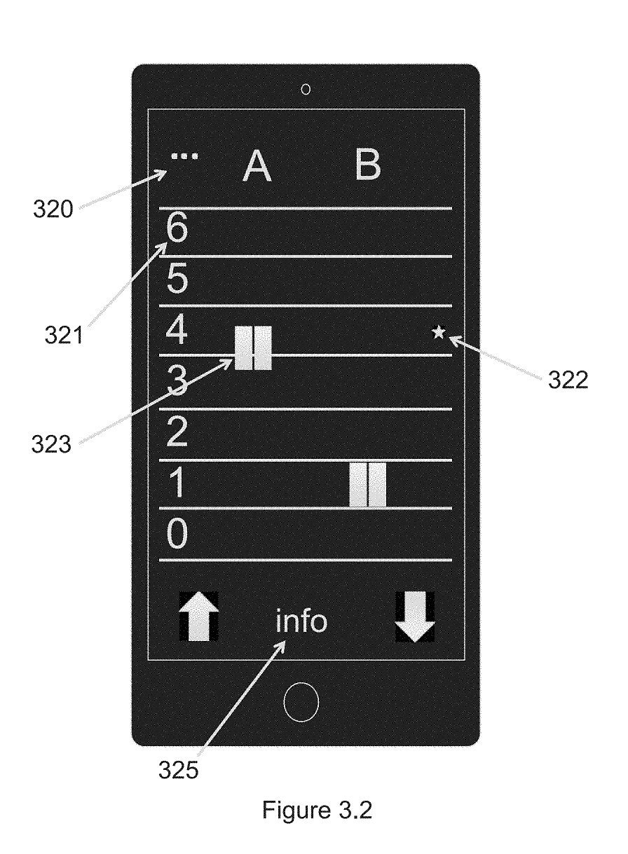

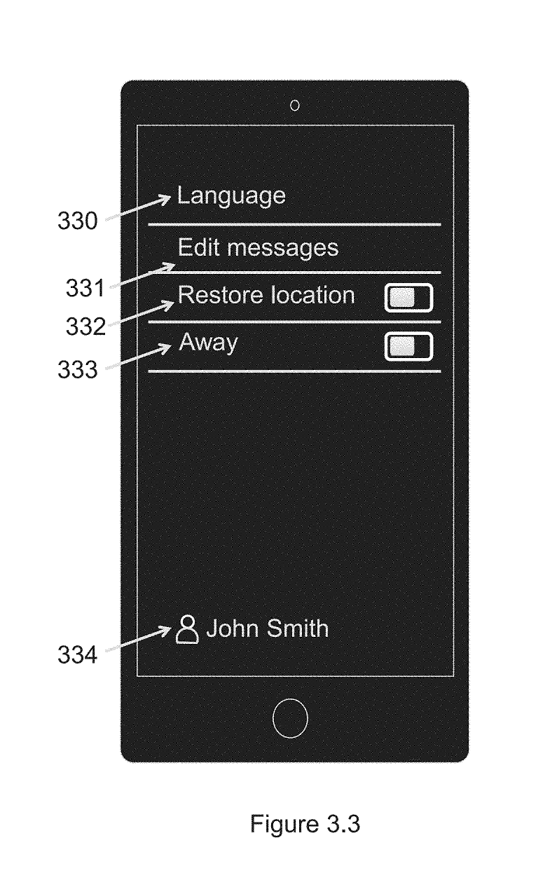

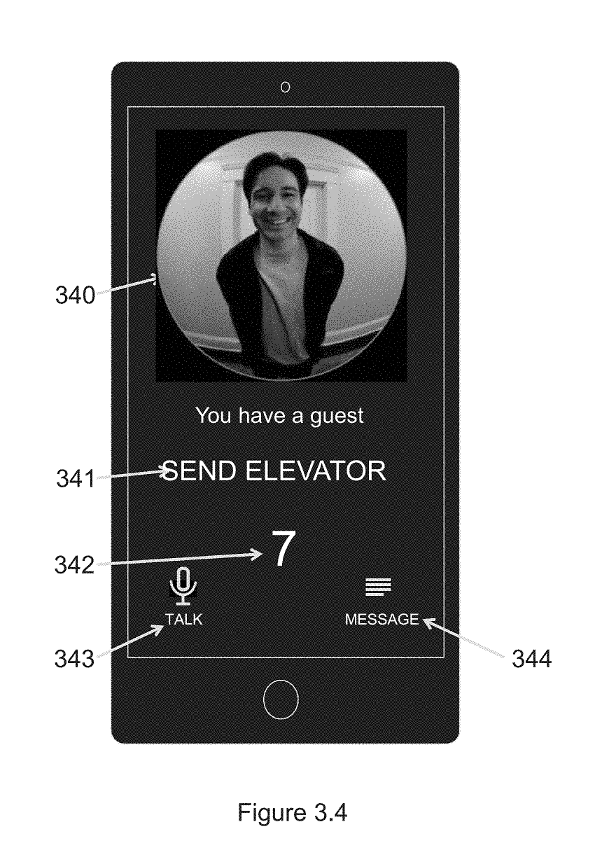

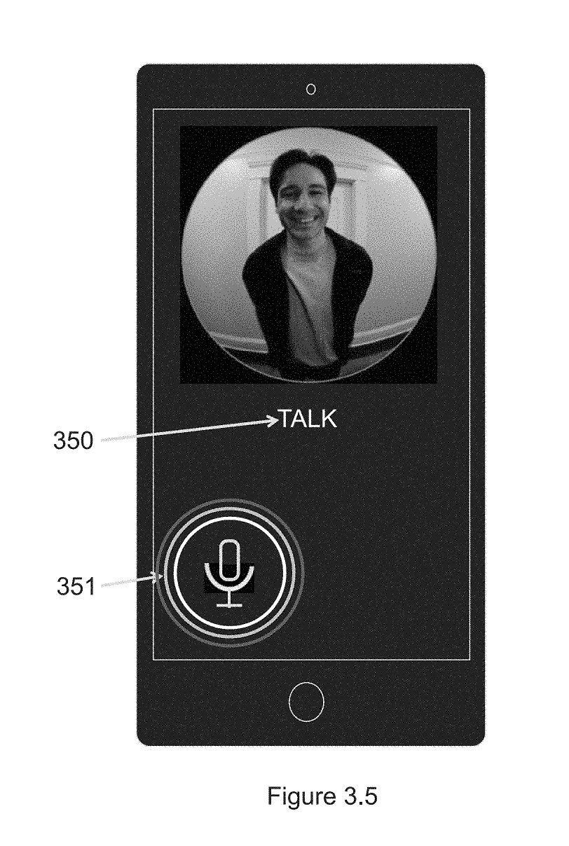

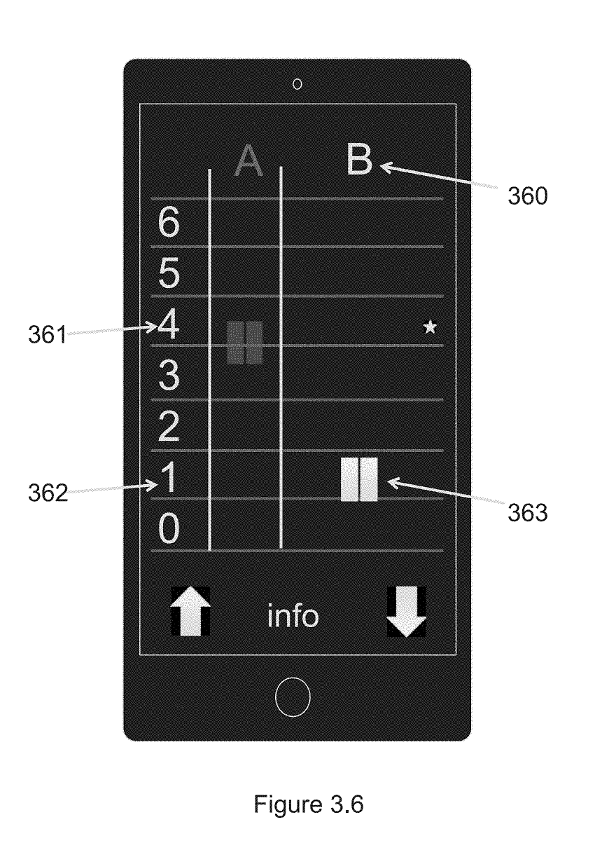

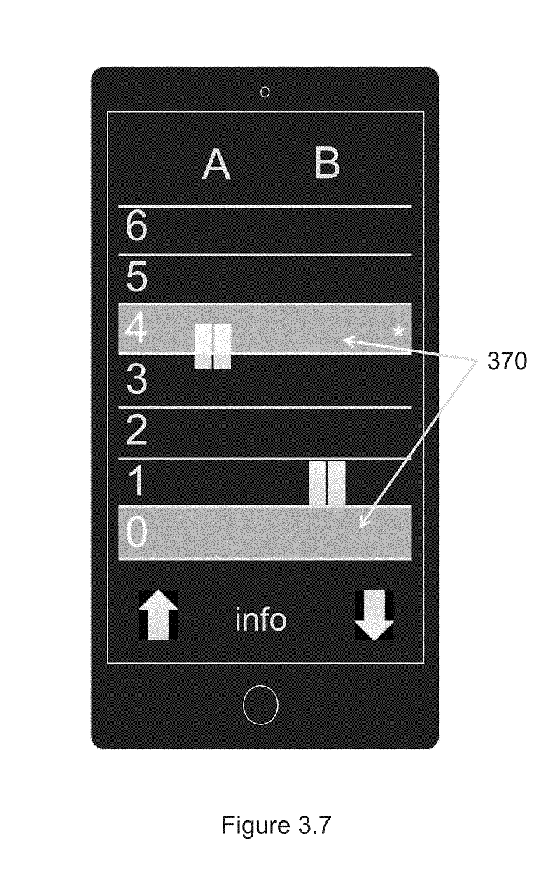

When the tenant or secretary user opens the mobile application (FIG. 3.4), a video stream 34 is sent from the tablet computer's 3 integrated camera through the system web server 1 to the tenant communication device mobile application 340. The tenant can then visually identify the visitor 35.

When the tenant is unable to identify 36 the visitor visually, one can optionally open an audio channel 37a, by pressing the speaker button 343 in the mobile application interface. This will stream the audio signal from the tenant communication device's 2 microphone to the system web server 1 and will be played from the tablet computer's 3 integrated speaker and vice versa. When the audio channel is opened 37a, the tenant is able to approach the visitor also verbally 38a and vice versa in order to identify the visitor and decide, whether to give access or not 39.

The tenant can optionally choose to send a predefined message 40a by opening the messages section 344 in the mobile application interface FIG. 3.4. The tenant can then select an appropriate predefined message 41a from the menu and send it by press on the chosen message in the mobile application interface. The message is then sent trough the system web server 1 and displayed 42a in the tablet computer mobile application 3.

The tenant can optionally choose to forward the call 40b to the predetermined secretary user by pressing the forward button in the communication device mobile application interface. The process is then repeated for the secretary users starting from the point number 32.

If the tenant does not take any action, the call will be forwarded automatically to the secretary user.

When the tenant positively identifies the visitor, the tenant can press the grant access button 341 in the mobile application interface. The access command is then sent 40 to the system web server 1, where the current floor the tenant is on 10 and the fixed floor 10 where the active tablet computer is located 1 are verified 41. The request for a destination call is then sent 42 to the elevator provider's web server 7. The elevator provider web server will trigger an elevator to deliver the visitor from the predefined tablet computer location floor to the current tenant location floor.

The tenant can change its current location any time by holding the tenant location button 322 on the communication device screen view FIG. 3.2 and dragging the indicator to the desired floor 321.

When the elevator has been engaged, the elevator provider's web server 7 will send 44 information about the elevator 12 such as which elevator is being used, destination call details and the current status of the elevator to the system web server 1.

The data about the destination call, the name/tag of the elevator in use, the current status and the location of the elevator will be sent from the system web server 1 to the tablet computer 1 and displayed in the tablet computer mobile application 45.

The visitor can then enter the elevator and is automatically delivered to the tenant's current location floor 48.

The data about the elevator such as which elevator is being used, the current status and the location of the elevator will be sent from the system web server to the tenant communication device 2 and displayed 46 in the tenant communication device interface.

If the tenant mobile application is closed when the elevator reaches the destination floor a notification will automatically be sent from the system web server to the tenant communication device 47. This will allow the tenant to know exactly when the visitor has been delivered to the tenant's location.

An additional feature of the system is a system process log, that is created of all the activities and processes (FIG. 1.2) that are requested from the system web server 1. The process log can be reached from both the building manager web interface 6 and the tenant manager web interface 5. The tenant manager can only access the process log of the tenant users and user groups assigned under that tenant, whereas the building manager can access the process logs of the entire building. The process logs include date and time of an activity, the tenant group involved, the tenant name, result of the access request, the elevator block in action, starting and destination floor of the destination call, intermediate stops during the visitor delivery and the priority of the call.

FIG. 2.1 is a schematic view of the screen layout of a tablet computer mobile application during the building manager identification and activation process of the tablet mobile application. The schematic view in FIG. 2.1 of the screen layout includes a username field 210 and a password field 211 for logging in to the tablet computer mobile application interface and a login confirmation button 212 for confirming the login activity. The username is the building manager's contact e-mail address and the password is generated by the building manager in the building manager web interface.

FIG. 2.2 is a schematic view of the screen layout of a tablet computer mobile application when it is in standby mode. The schematic view in FIG. 2.2 of the screen layout includes a language button 220; to change interface language between given languages; an users list button 221 for directly selecting the tenant person from the complete user list; an alphabetical scrolling bar 222 for navigating in the displayed list of names in an alphabetical order; an action indicator 223 for describing the activity in process in the current screen view; a confirmation button 224 for confirming the desired tenant group selection from the list of tenant groups 225

FIG. 2.3 is a schematic view of the screen layout of a tablet computer mobile application when the user makes the selection to find tenants by their names from the list of all tenant names 232. The schematic view in FIG. 2.3 of the screen layout includes a tenant group list button 230 to optionally go to the standby mode screen described in FIG. 2.2 and to choose the tenant from a certain tenant group

FIG. 2.4 is a schematic view of the screen layout of a tablet computer mobile application after the user has selected a certain tenant group. The schematic view in FIG. 2.4 of the screen layout includes a tenant group selection indicator 240 for displaying the current tenant group where the tenant is currently been searched from and a home button for getting back to the standby screen view shown in FIG. 2.2.

FIG. 2.5 is a schematic view of the screen layout of a tablet computer mobile application after the user has selected the tenant name and during the process of waiting for a response from the tenant. The schematic view in FIG. 2.5 of the screen layout includes a video window 250 for displaying the video stream from the tablet computer's integrated, a timer 251 which shows the maximum time remaining until the action will be stopped, the name of the tenant whom the visitor is trying to reach 252 for communicating the visitor to whom is the current call being made to and a cancel button 253 for cancelling the call.

FIG. 2.6 is a schematic view of the screen layout of a tablet computer mobile application that shows the destination floor and elevator to be used after once the tenant has given the permission to access. The schematic view in FIG. 2.5 of the screen layout shows which elevator the visitor needs to take 260, the floor that has been set as the destination 261 an elevator status indicator for showing the current status of the elevator in service.

FIG. 2.7 is a schematic view of the screen layout of a tablet computer mobile application when the message from the tenant or system is shown after the request has not been answered or access denied. The screen layout includes a message board 270 for displaying the message sent by the tenant user, when rejecting the visitor.

FIG. 3.1 is a schematic view of the screen layout of a tenant communication device during the tenant identification process. The schematic view in FIG. 3.1 of the screen layout includes a tenant username field 311 and a tenant password field 312 for logging into the mobile application.

FIG. 3.2 is a schematic view of the screen layout of a tenant communication device when the mobile application is not processing any requests. The schematic view of the screen layout includes a settings button 320 for entering the settings panel shown in FIG. 3.3, an elevator panel indication for showing graphically the elevators operating in the building, a floors list 322 for displaying graphically all the floors of the building, a tenant location indicator and button 323 which shows the current location of the tenant, default arriving floor of the destination call for the visitor and for changing the current location of the tenant, an elevator status indicator 323 for showing the current position and status of the elevator, an information button 325 for information and guidance for navigating in the current view.

FIG. 3.3 is a schematic view of the screen layout of the tenant communication device mobile application's settings panel. The schematic view of the screen layout includes a language button 330 for accessing and selecting the interface language, a message editing button 331 for accessing and editing the various predefined messages, a host location resetting switch 332 to enable and disable automatic host location resetting to default location, an “away”—mode switch 333 to turn on and off the function to automatically forward calls to the predefined secretary user, a logout button 334 for logging out of the system interface.

FIG. 3.4 is a schematic view of the screen layout of a tenant mobile application when there is an identification request in process. The schematic view of the screen layout includes a video window 340 for displaying the video stream from the tablet computer's integrated camera in order to identify the visitor visually, an accept call button 341 for approving the visitor's request and ordering the destination call from the area where the tablet computer is located to the area where the host is located, a timer 342 showing the time remaining to make a decision, before the call is forwarded or ended, an audio channel button 343 for opening the audio channel between the tenant communication device and tablet computer, a rejection message button 344 for rejecting the visitor and by displaying a predefined message 270 in the tablet computer mobile application.

FIG. 3.5 is a schematic view of the screen layout of a tenant mobile application when the audio channel is active. The schematic view of the screen layout includes a current activity indication 350 for showing the activity at hand, an audio channel indicator 351 for showing graphically that the audio channel is currently opened

FIG. 3.6 is a schematic view of the screen layout of a tenant mobile application, when the visitor delivery is in progress. Schematic view in FIG. 3.6 of the screen layout includes a highlighted elevator 360 which indicates the elevator servicing the current call, a highlighted destination floor 361 which clearly shows the destination of the current call, a highlighted starting floor 362 which displays the starting floor of the destination call, a status indicator 363 showing the current status of the destination call.

FIG. 3.7 is a schematic view of the screen layout of a tenant mobile application, when the tenants request an elevator for themselves. Schematic view in FIG. 3.7 of the screen layout includes highlighted floors 370, for indicating where the call has been made from and what is the destination floor.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. The method for mobile visitor identification and selectively allowing automated elevator usage to the destination selected by the tenant comprises an elevator system, which elevator system comprises an elevator provider web server and at least one elevator, by registering an destination call via an application programming interface for transmitting data related to the destination call, wherein the method comprises:
a request for connection to a predefined system user or a tenant selected by the visitor is sent from a tablet computer mobile application to a system web server;
a request for opening a mobile application is sent to a tenant communication device;
an audio and video stream from said tablet computer mobile application to said mobile application is opened;
a confirmation is sent by the tenant from said mobile application to said system web server;
a location floor of the tenant and the visitor is verified in said system web server said location floor of the tenant and the visitor is sent from said system web server to said elevator provider web server.

2. Method according to claim 1, wherein said audio and video stream is automatically opened when said mobile application is opened in said tenant communication device.

3. Method according to claim 1, wherein a request for connection is redirected to a predefined tenant user if said mobile application is not opened in said tenant communication device within a predefined time.

4. Method according to claim 1, wherein said location floor of the tenant is registered in said system web server.

5. Method according to claim 1, wherein the location of the visitor is defined by the location of the tablet computer; and the location of said tablet computer is registered in said system web server.

6. Method according to claim 1, wherein statistical data about the registered destination calls are collected.

7. A system for mobile visitor identification and selectively allowing automated elevator usage to the destination selected by the tenant according to the method defined in claim 1, the system comprising:
a web server for storing the website, user databases and for facilitating the process of connecting the tablet computer, a tenant communication device and the elevator provider's web server;
a building manager computer interface which is used to access the website in the web server to insert and administrate data in the building databases;
a tenant manager computer interface is used to access the website in the web server, to insert and administrate the tenant mobile application access, access floors and access elevator groups;
a tablet computer that is used as a hardware platform to interact with the mobile tablet application, the tablet allows to:
request contact with the tenant by first selecting the desired company and then the specific person from the tablet computer user interface;
display messages that help guide the visitor through the process of requesting access;
communicate with the visitor through an integrated tablet loudspeaker;
an integrated camera of the tablet computer that is used to capture a live footage of the visitor, who is requesting access to the secured area of the building;
wherein the system comprises:
the elevator provider's web server, that is communicated via the application programming interface, it is given by the elevator provider for sending the elevator operational requests, requests for information and for receiving information about the building and elevator;
a tenant communication device that is used as a hardware platform to interact with said mobile application, the tenant communication device allows to:
receive the live stream sent from the tablet computer through the web server;
send elevator action requests to the web server which will communicate with the elevator provider's web server;
receive and display data about the elevator.

8. A system according to claim 7, wherein the tenant communication device is a mobile telephone, a tablet computer or similar device.
